(19) United States
(12) Patent Application Publication
(10) Pub. No.: US 2007/0202220 A1
(43) Pub. Date: Aug. 30, 2007

(54) Food storage preserver

(76) Inventor: Susan T. Dicosola, White Plains, NY (US)

Correspondence Address: Ward & Olivo, Suite 400, 382 Springfield Avenue, Summit, NJ, 07901, US

(21) Appl. No.: 11/364,155

(22) Filed: Feb. 28, 2006

(51) Int. Cl. A23B 7/148

(52) U.S. Cl. 426/106

(57) ABSTRACT

The present invention is an improved food storage container. The container can be a re-sealable flexible bag or a semi-rigid container, either of which is coupled to an absorbent pad. The absorbent pad absorbs excess liquid eluted from the food stored within or formed by condensation during refrigeration. As a result, the liquid is transported away from the food located in the container via capillary action, reducing rotting, reducing the formation of bacteria without the use of potentially harmful chemicals, preservatives, or other additives, which prolongs the storage life, quality, and nutritional value of foods products kept within the container.

### FIELD OF THE INVENTION

The invention relates generally to the field of food storage. More specifically, the current invention discloses an improved food storage container comprising absorbent material which prolongs the storage life, quality, and nutritional value of foodstuff kept within the container by absorbing eluted liquid.

### BACKGROUND OF THE INVENTION

To combat the skyrocketing prices of food, particularly fresh food products, budget conscious consumers purchase food in bulk which is cheaper on a per pound basis. As a result, the typical consumer acquires more food than is necessary for a given meal. In addition, it is commonplace for food to be left over from prepared meals. To preserve the unused purchased portion and/or any left over portion, the consumer repackages the food purchased in bulk and/or the leftovers. After the food is repackaged, it can be refrigerated to further preserve the food for highly perishable items such as meat, or stored at room temperature on a shelf or counter top for items such as breads, rolls, and the like. Typically, the consumer utilizes a re-sealable plastic bag or other reusable, semi-rigid container (e.g., a wax paper bag or Tupperware®).

Further, day to day activities in today's fast-paced society consume a large part of the day. Consequently, time pressed individuals streamline their activities to minimize the amount of time dedicated to a single task. For example, many individuals cook only once or twice a week. During this time, the individual prepares one large meal or multiple smaller meals. These individuals rely on conventional food storage containers. Indeed, the ubiquitous presence of these containers for sale in supermarkets, convenience stores, and retail stores underlies the importance of preserving and storing food.

Traditional storage devices, including semi-rigid containers, wax paper bags, and re-sealable plastic bags form a semi-closed system when utilized properly. When these containers are placed in storage, either at room temperature or in a refrigerator, condensation forms on the interior surface of the container. In addition, water and other natural juices elute from the food product contained in the storage container via diffusion. As a result, a significant amount of fluid accumulates in the storage container. The resulting pool of liquid not only soaks the food product but acts as a fertile breeding ground for bacteria and facilitates its rapid growth. The bacteria laden liquid then facilitates the migration back to the food product, resulting in rapid discoloration, decreased nutritional content, and spoiling. Accordingly, the food product quickly becomes unusable.

Similar problems arise when displaying other food products such as fruits, vegetables, breads, and the like. Display containers typically comprise a semi-rigid foam tray to hold the food product which is wrapped in cellophane to prevent open air exposure. However, these containers also suffer from problematic liquid formation.

In an attempt to alleviate these problems and extend the shelf-life of such food products, supermarkets utilize an absorbent pad comprised of tissue-like paper. However, the padding utilized in these containers maintains direct contact with the food, allowing significant migration of the bacteria back to the food product to occur. In addition, the tissue like paper is not reusable. Accordingly, the home user has no food container device which can be utilized to reduce the formation of a pool of liquid within a food storage container.

Alternatively, preservatives can be added to the food product to prevent the formation of bacteria. However, the compositions utilized to retard bacteria growth can only safely be used in small amounts. As a result, the efficacy of these compounds is extremely limited. In addition, many consumers are loath to ingest synthetic chemicals and the like due to the fear of detrimental long term health effects. Further, the use of preservatives does not reduce the amount of liquid which is formed in a food storage container. Moreover, these compounds are not readily available to the typical post-production user. Consequently, utilizing preservatives does not reduce the unsightly discoloration that may occur. Accordingly, the use of preservatives is impractical, inefficient and undesirable.

In light of the foregoing, there exists a clear need in the art for a food storage device which can be utilized at home for improving the shelf life, quality, and nutritional value of food products by reducing the amount of liquid which interacts with the food product contained within. In addition, there is a clear need in the art for a food storage device which does not utilize potentially harmful chemicals. The present invention provides an improved food storage device which combines all of the aforementioned benefits without any of the shortcomings associated with traditional food storage containers.

### SUMMARY OF THE INVENTION

The present invention comprises an improved food storage system comprising a container and an absorbent pad. The container can be a re-sealable flexible bag a semi-rigid container, a wax paper bag, or any other well known storage device which is coupled to an absorbent pad. The absorbent pad absorbs excess liquid eluted from the food stored within and formed by condensation during refrigeration. As a result, the liquid is transported away from the food located in the container via capillary action, keeping the food dry and reducing the formation of bacteria without the use of potentially harmful chemicals, preservatives, or other additives. In addition, the retardation of bacteria formation maintains the nutritional content of the food, thereby increasing the quality of the stored product.

The absorbent pad is comprised of an absorbent material. Optional fenestrations are provided to increase the surface area of the material provided as well as to act as an adjunct in fixation of the material to the container. Advantageously, the absorbent material is comprised of a mechanically sound material (i.e., it does not readily dissolve in a liquid). As a result, it is possible to store liquids within the containers without the risk of contamination, tearing, or dissolving of the absorbent material into the food. Accordingly, the food storage preserver of the present invention can store solids, or semi-solid foods.

The absorbent material is coupled to a container in one of several well known ways. For example, the absorbent material can be heat sealed along a line that fixes both sides of the bag to each other through the material at the bottom of the bag. In short, this permanently attaches the absorbent material to the bag while minimizing any deleterious effects to the volume of the bag.

As another example, the absorbent material can be permanently affixed to a rigid container (e.g., Tupperware®) along the sides or the bottom of the container via one or more plastic “rivets.” These rivets, which are known in the art, are attached through the material and heated to form a permanent bond to the container. No chemicals, glues, or other adhesives are utilized.

Of course, it is not necessary that the absorbent material is permanently attached to the food storage container. Indeed, the absorbent material can simply be placed within a storage container, it need not be fixedly attached to it.

Advantageously, the present invention absorbs excess liquid formed by condensation when food is stored in a refrigerated medium. Any excess fluid that elutes from the food due to diffusion is absorbed as well. These liquids are well known breeding grounds for bacteria which can discolor or spoil food. Accordingly, the present invention provides for a storage container which provides longer food shelf life without the addition of potentially harmful additives, preservatives, or other chemicals. In addition, the retardation of bacteria formation maintains the nutritional content of the food, thereby increasing the quality of the stored product.

In light of the foregoing, it is an object of the invention to create an improved food storage container.

Still another object of the current invention is to create an improved food storage container which comprises a flexible, re-sealable bag.

Further, it is an object of the current invention to create an improved food storage container which comprises a rigid container.

Yet another object of the present invention is to preserve the shelf life of food stored in a container without utilizing preservatives, additives, or other chemicals.

Still another object of the present invention is to reduce the appearance of food breakdown in a food storage container.

Further, it is an object of the present invention to maintain the nutritional content of stored food products.

Still another object of the present invention is to improve the quality of stored food products.

Yet another object of the present invention is to keep the food dry and prevent food from quickly rotting.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention. Reference is now made of the drawings in which:

FIG. 1 shows a perspective view of a food storage container which comprises a re-sealable bag in accordance with the present invention

FIG. 2 shows a sectional view of the food storage container according to the present invention taken along line 2-2 in FIG. 1

FIG. 3 shows a sectional view of an alternative food storage container according to the present invention taken along line 2-2 in FIG. 1

FIG. 4 is an exploded perspective view of the food storage container which comprises a semi-rigid container in accordance with the present invention

FIG. 5 is an enlarged, fragmentary sectional elevation view showing the bottom of the container and the absorbent pad in accordance with the present invention

FIG. 6 is an enlarged, fragmentary sectional elevation view showing an alternative configuration of the bottom of the container and the absorbent pad in accordance with the present invention

FIG. 7 is an enlarged, fragmentary sectional elevation view showing yet another alternative configuration of the bottom of the container and the absorbent pad in accordance with the present invention

FIG. 8 is an enlarged, fragmentary sectional elevation view showing still another alternative configuration of the bottom of the container and the absorbent pad in accordance with the present invention.

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein that define the scope of the present invention.

Initially, the use of the terms “container,” “device,” “food storage device,” food storage container,” “insert” and the like are not meant to limit the scope of the present invention. Rather, the terms are used interchangeably and are meant to be merely illustrative in nature of certain aspects of the present invention.

Further, the use of the term “bacteria” is not intended to limit the scope of the present invention to a particular microorganism. Rather, the use of the term “bacteria” is merely illustrative of any type of microorganism that can impact the quality, shelf life, or nutritional value of food, including but not limited to viruses, fungi, protozoa, and helminths.

In addition, the preferred embodiment of the present invention describes the absorbent material as a rectangular pad, however, it is not meant to limit the scope of the present invention. The term is meant to be merely illustrative in nature of certain aspects of the present invention, as various shapes and configurations of the material can be utilized in accordance with the present invention. In addition, the preferred embodiment of the present invention depicts the absorbent material as occupying the entire surface area of a food storage device. However, it is contemplated that less absorbent material can be used (i.e., an amount that covers only a portion of the interior surface area of a food storage container) in accordance with the present invention.

Moreover, well known methods, procedures, and substances for both carrying out the objectives of the present invention and illustrating the preferred embodiment are incorporated herein but have not been described in detail as not to unnecessarily obscure aspects of the present invention. The following presents a detailed description of a preferred embodiment of the present invention.

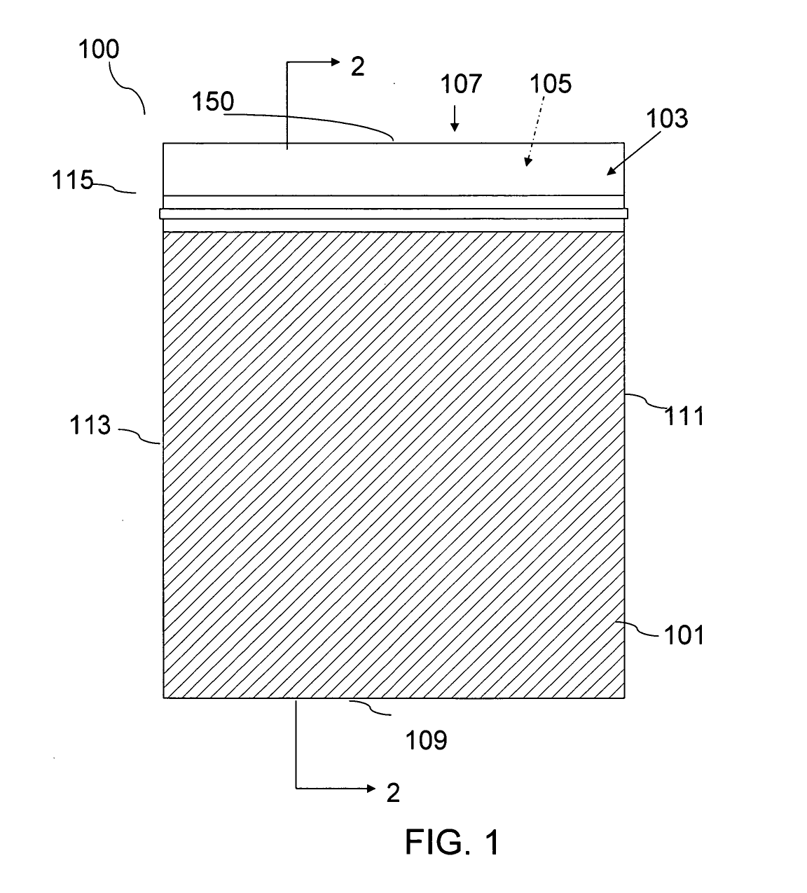

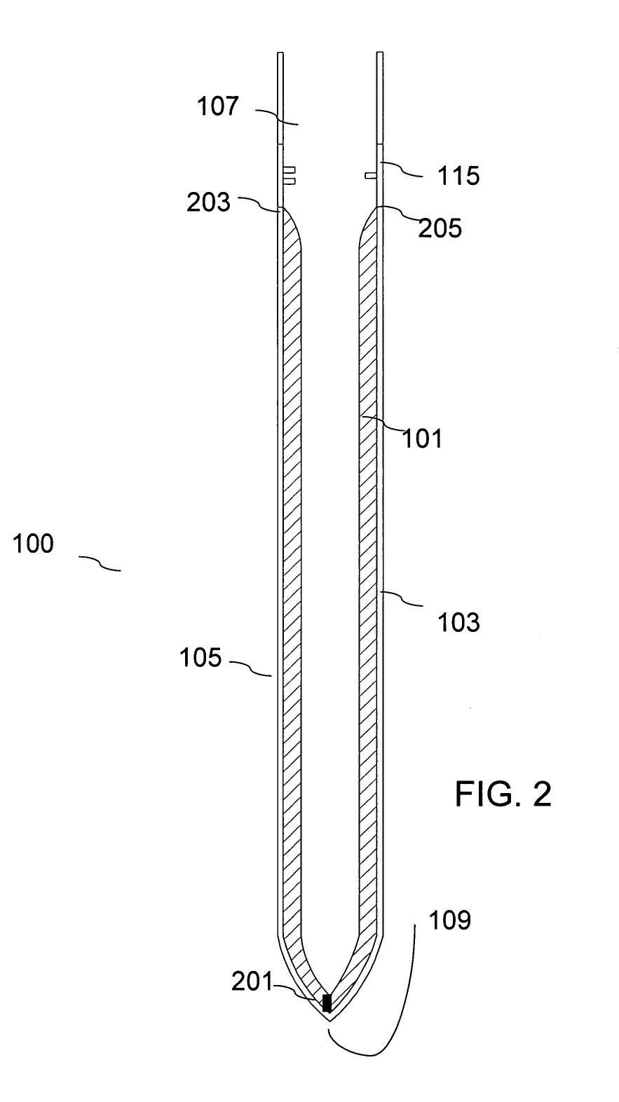

Referring now to FIGS. 1-2, shown is a food storage container in accordance with the preferred embodiment. In this example, food storage container 100 is flexible plastic bag 150. The bag comprises top 107, opposing sides 103 and 105 which form opposing lateral edges 111 and 113, and bottom 109. Food storage container 100 also comprises re-sealable mechanism 115, described in greater detail below. Absorbent material 101 is attached at one or more of points 201, 203, or 205 to flexible bag 150 as discussed in greater detail below.

Flexible bag 150 may be comprised of any one of a variety of structures, such as a standard freezer bag or any known ZIPLOC® brand plastic bag sold by S.C. Johnson Home Storage, Inc. of Racine, Wis. A standard quart or gallon bag is preferred as flexible bag 150, but other bag sizes may be used in accordance with the present invention.

As shown in FIGS. 1-2, flexible bag 150 is formed from a single sheet of material that is folded to form opposing sides 103 and 105 and bottom 109. Opposing sides 103 and 105 are attached to each other at lateral edge 111, lateral edge 113 and bottom 109 by utilizing the known process of heat sealing. Of course, any other known method of attaching opposing sides can be utilized in accordance with the present invention. As a result of this process, flexible bag 150 forms a hollow recess suitable for storing food.

Although flexible bag 150 is preferably formed from a single sheet folded at bottom 109, flexible bag 150 does not need to be formed from a single sheet. For example, flexible bag 150 can be formed from separate sheets are attached at lateral edges 111, 113 and at bottom 109 of flexible bag 150.

Flexible bag 150 is preferably comprised of a thermoplastic material or a blend of thermoplastic materials. Of course, flexible bag 150 can be comprised of other materials in accordance with the present invention. For example, flexible bag 150 can also be made from a plurality of layers of co-extruded films. This technique is disclosed in U.S. Pat. No. 5,292,392 to Miller, et al., herein incorporated by reference. Flexible bag 150 is preferably comprised of a material that is at least partially impermeable to air and water.

Suitable thermoplastics include, for example, polyolefins such as high density polyethylene (HDPE), low density polyethylene (LDPE), linear low density polyethylene (LLDPE), and polypropylene (PP); thermoplastic elastomers such as styrenic block copolymers, polyolefin blends, elastomeric alloys, thermoplastic polyurethanes, thermoplastic copolyesters, and thermoplastic polyamides; polymers and copolymers of polyvinyl chloride (PVC), polyvinylidene chloride (PVDC), S.C. Johnson & Son, Inc.'s SARAN polymers (Racine, Wis.), ethylene/vinyl acetate copolymers, cellulose acetates, polystyrene, thermoplastic polyvinyl alcohols; single site catalyst resins; and nylons such as non-crystalline nylons and amorphous nylons. Preferably, flexible bag 150 is comprised of polyethylene and more preferably from a blend of low density polyethylene (LDPE) and linear low density polyethylene (LLDPE), which is preferred for its greater tear strength.

The thickness and strength of the material used for flexible bag 150 may vary widely. However, the material should be thick enough and strong enough to resist punctures. Thus, the thickness of the material can be anywhere from 1 to 4 millimeters and preferably has an elastic modulus below 50,000 pounds per square inch. Alternatively, thicker components may be used if extra puncture resistance is desired for certain applications.

In an alternative embodiment, flexible bag 150 is comprised of paper or lined paper. For example, traditional wax paper bags, which are commonly utilized for storing cereals, grains, and other dry food products, are particularly suited for use in accordance with the present invention. A wax paper bag coupled to the absorbent material of the present invention allows a user to keep grains, and the like from becoming saturated with moisture, which prevents the food product from becoming moldy. Of course, it is contemplated that other materials can be utilized in accordance with the present invention.

Re-sealable mechanism 115 comprises two mating elements which, when closed, prevent the passage of fluid. Any closure may be used to close flexible bag 150, including, as non-limiting examples, a zipper, a zipper with a sliding closing mechanism, an adhesive strip, a hook-and-loop fastener, snaps and buttons, and a tying mechanism such as string or a thin metal wire. The process of adding a closing mechanism is well known, and is taught, for example, in U.S. Pat. No. 5,012,561, to Porchia, et al. and U.S. Pat. No. 5,070,584 to Dais, et al., each of which is incorporated herein by reference.

Many variations of flexible bag 150 are possible. For example, flexible bag 150 can be a variety of different colors. Flexible bag 150 may have curled in or curled out edges at top 107. Alternatively, flexible bag 150 can have a print strip (not shown) which allows a user to label the contents of the container.

Absorbent material 101 preferably comprises a pad of liquid absorbent material, the thickness of which may be varied to control the absorbency thereof. Typically, the thickness is between about 1/32 to ⅛ inches so as to permit absorption and retention of a substantial quantity of liquid. A number of different materials may be used, such as stacked layers of tissue-like wadding, a mat of conventional defiberized wood pulp (known in the art as wood fluff), a mat of synthetic pulp such as rayon, a mat of cotton, a mat of absorbent paper, fenestrated cloth, a fenestrated compressed sponge, composite materials, or combinations of the above, either with or without fenestrations.

In one embodiment of the present invention, absorbent material 101 is comprised of hydrophilic cellulose base fibers. Other preferred materials include a layer of wood fluff in conjunction with a thin layer of tissue-like paper wadding. Wood fluff is well known in the art and consists of defiberized cellulose fibers which have been formed into a compressed batt in the manner of a non-woven fabric. The fluff layer has little or no consistency or integrity, and it is thus difficult to maintain in web form during manufacturing operations. The paper wadding, which is also known in the art, is produced on a paper making machine, and may, if desired, be creped for added body. The wadding typically has a texture similar to household facial tissue, and has substantially more integrity than does the wood fluff.

The layers of wadding and wood fluff are superposed and mechanically interconnected by diamond-shaped embossing and/or fenestrations illustrated by parallel lines on absorbent material 101 in the accompanying FIGS. 1-8. Advantageously, theses features maintain the relative positioning of the layers and the integrity of the wood fluff. In addition, the fenestrations facilitate adhering absorbent material 101 to flexible bag 150. The embossing comprises myriad distinct indentations along the lines of the diamond-shaped pattern and which serve to compact and thereby interconnect the superposed layers along those lines.

Absorbent material 101 is attached to flexible bag 150 at one or more locations. Preferably, absorbent material 101 is attached to flexible bag 150 by one or more heat sealing lines 201, 203, and 205. In the preferred embodiment, absorbent material 101 is heat sealed through the fenestrations and/or diamond shaped embossing in such a manner as to reduce any potential negative effect on the volume of flexible bag 150. Advantageously, this process does not utilize any adhesive, glue, or other potentially harmful chemical. Of course, any other means for attaching absorbent material 101 to flexible bag 150 can be utilized in accordance with the present invention as long as it does not use harmful chemicals.

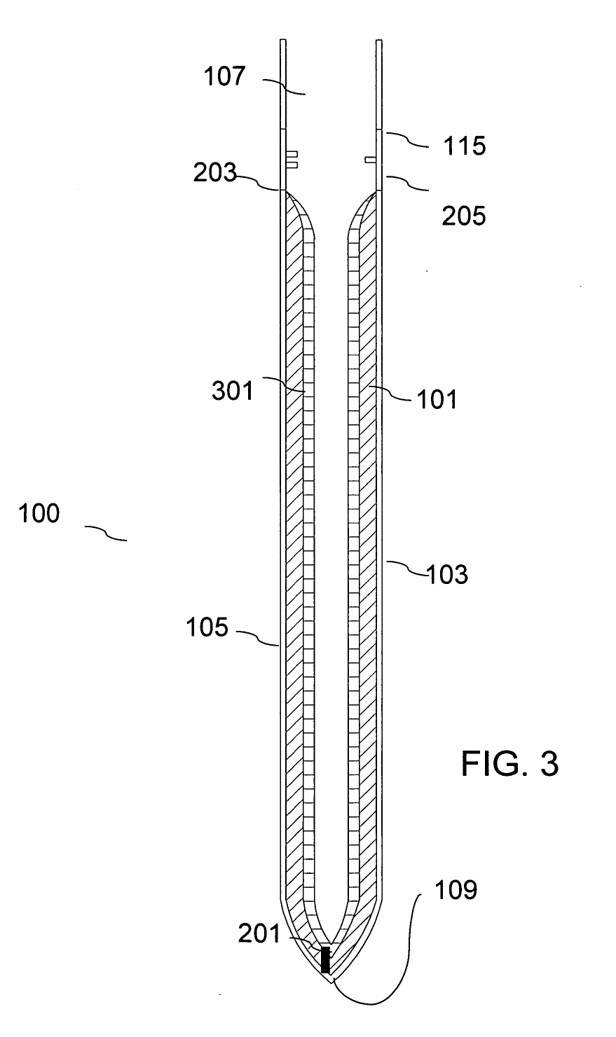

As depicted in FIG. 3, an optional semi-permeable sheet 301 can be utilized in accordance with the present invention. Semi-permeable sheet 301 is comprised of a material which is non-reactive to food products. For example, semi-permeable sheet 301 may comprise a flexible thermoplastic film, such as polyethylene having a thickness between about 0.00035 to 0.005 inches. The peripheral edges of semi-permeable sheet 310 is preferably sealably secured together by any suitable means, such as a hot melt adhesive seal or by heat sealing to thereby sealably enclose the mat of absorbent material 101 between semi-permeable sheet 301 and flexible bag 150. In addition, the semi-permeable sheet 301 comprised a plurality of minute pores which permit liquid to pass from the exposed surface of semi-permeable sheet 301 to absorbent material 101. Preferably, the pores are uniformly distributed over the surface area of semi-permeable sheet 301. Also, semi-permeable sheet 301 is preferably oriented so that the peripheral portions extend toward absorbent material 101, which acts to retard the diffusion of liquid outwardly from absorbent material 101.

In use, juices exuded from the food product stored in food container 100 or condensation formed during refrigeration flows through semi-permeable sheet 301 (if present) into absorbent material 101. The capillary action of absorbent material 101 draws the liquids into the pad where they are prevented from resaturating the food product. Optional semi-permeable sheet 301 helps to prevent the absorbed liquids from directly contacting the food product, and the capillary action of absorbent material 101 (and the small size of the pores of semi-permeable sheet 301 if utilized) acts to retard the reverse flow of the liquids through the openings. As a result, the exuded liquids do not come into contact with the food product stored in food container 100, reducing rotting, reducing the appearance of food breakdown and the formation of bacteria.

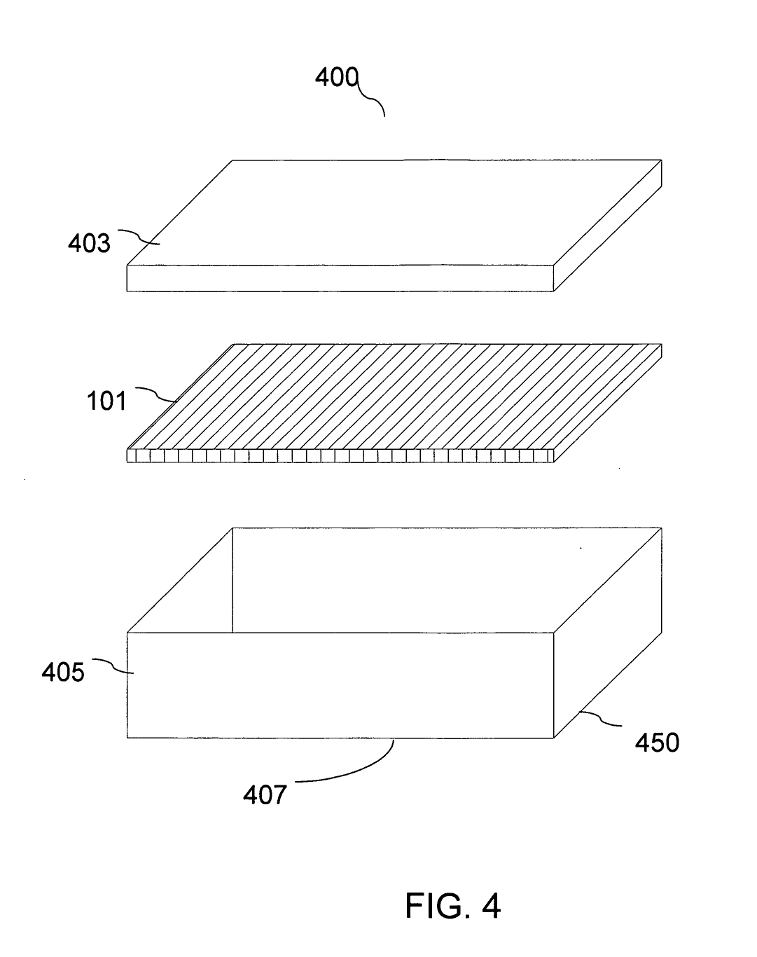

Referring next to FIG. 4, disclosed is another example of a food storage container in accordance with the present invention. As shown, food storage container 400 comprises rigid storage container 450, which comprises sidewall 405 and bottom 407, absorbent material 101, and lid 403.

Rigid storage container 450 comprises bottom 407 and sidewall 405. Preferably, sidewall 405 extends upward from bottom 407 and is attached to form a perimeter. As shown, sidewall 405 is square shaped, however, other shapes, such as ovular and circular, can be utilized in accordance with the present invention. Rigid storage container 450 also comprises lid 403, which is adapted to snugly fit over the perimeter formed by sidewall 405.

In the preferred embodiment, rigid storage container 450 and lid 403 are comprised of a thermoplastic material or a blend of thermoplastic materials. Of course, rigid storage container 450 can be comprised of other materials in accordance with the present invention.

Suitable thermoplastics include, for example, polyolefins such as high density polyethylene (HDPE), low density polyethylene (LDPE), linear low density polyethylene (LLDPE), and polypropylene (PP); thermoplastic elastomers such as styrenic block copolymers, polyolefin blends, elastomeric alloys, thermoplastic polyurethanes, thermoplastic copolyesters, and thermoplastic polyamides; polymers and copolymers of polyvinyl chloride (PVC), polyvinylidene chloride (PVDC), S.C. Johnson & Son, Inc.'s SARAN polymers (Racine, Wis.), ethylene/vinyl acetate copolymers, cellulose acetates, polystyrene, thermoplastic polyvinyl alcohols; single site catalyst resins; and nylons such as non-crystalline nylons and amorphous nylons.

Absorbent material 101 is constructed in a manner as previously described.

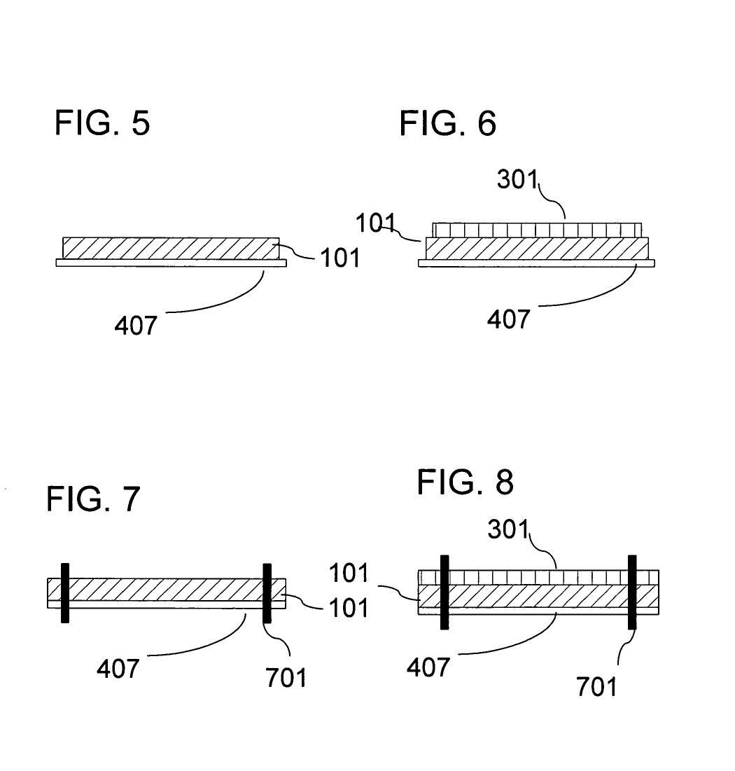

Referring next to FIGS. 5 & 7, shown are cross-sectional views of the attachment of absorbent material 101 to rigid container 450. FIG. 5 depicts absorbent material 101 attached to bottom 407 of rigid container 450 by heat sealing. Alternatively, as shown in FIG. 7, absorbent material can be attached to bottom 407 via one or more plastic rivets 701. In addition, absorbent material 101 can be attached to lid 403 of rigid container 450. These well known rivets 701 are attached to bottom 407 through the pores of absorbent material 101 and heated from the underside of bottom 407 which effectively “melts” the bottom of rivet 701.

In the alternative examples of FIGS. 6 & 8, food storage container 400 further comprises option semi-permeable sheet 301, constructed in a manner as previously described.

As in other embodiments, FIGS. 6 & 8 show the interaction of attachment between bottom 407, absorbent material 101, and semi-permeable sheet 301 to create food container 400. In FIG. 6, the constituent parts are attached via heat sealing in a manner as previously described. FIG. 8 show the utilization of one or more plastic rivets 701, which are attached in a manner as previously described.

In use, food is placed into food storage rigid container 450 and the lid is snugly fitted onto sidewall 405. Juices exuded from the food product stored in food container 400 or condensation formed during refrigeration flows through semi-permeable sheet 301 (if present) into absorbent material 101. The capillary action of absorbent material 101 draws the liquids into the pad where they are prevented from resaturating the food product. Optional semi-permeable sheet 301 helps to prevent the absorbed liquids from directly contacting the food product, and the capillary action of absorbent material 101 (and the small size of the pores of semi-permeable sheet 301 if utilized) acts to retard the reverse flow of the liquids through the openings. As a result, the exuded liquids do not come into contact with the food product stored in food container 400, reducing rotting and reducing the appearance of food breakdown and the formation of bacteria.

What is claimed is:

1. A system for improving the storage life for food comprising:
a food storage container;
an absorbent pad;
wherein said absorbent pad is coupled to an interior of said storage container; and
wherein said absorbent pad reduces food breakdown by absorbing liquid contained within said food storage container;
wherein said system does not utilize preservatives or additives.

2. The system of claim 1, further comprising a refrigeration means.

3. The system of claim 1, wherein said food storage container comprises a re-sealable bag.

4. The system of claim 1, wherein said food storage container is semi-rigid.

5. The system of claim 1, wherein said absorbent pad comprises fenestrations.

6. The system of claim 1, wherein said absorbent pad comprises at least one selected from the group consisting of fenestrated cloth, fenestrated compressed sponges, and composite materials.

7. The system of claim 1, wherein said absorbent pad is coupled to said food storage container by at least one plastic rivet.

8. The system of claim 1, wherein said absorbent pad is coupled to said food storage container by a heat sealing line.

9. A food storage container comprising:
a flexible bag comprising at least two bag sides in an opposed relationship;
wherein each bag side comprises two lateral edges, a bag top extending from one lateral edge to another lateral edge, and a bag bottom in an opposed relationship to said bag top such that a hollow interior is formed; and
an absorbent pad;
wherein said absorbent pad is coupled to said hollow interior of said flexible bag.

10. The food storage container of claim 9 wherein said flexible bag further comprises a bag closure.

11. The food storage container of claim 9, wherein said absorbent pad comprises fenestrations.

12. The food storage container of claim 9, wherein said absorbent pad comprises at least one selected from the group consisting of fenestrated cloth, fenestrated compressed sponges, and composite materials.

13. The food storage container of claim 9, wherein said absorbent pad is coupled to said flexible bag by a heat sealing line.

14. The food storage container of claim 9, wherein said flexible bag is comprised of thermoplastic material.

15. A food storage container comprising:
a container comprising a bottom and at least one sidewall;
wherein said sidewall extends upward from said bottom and forms a perimeter around said bottom, thereby creating a hollow interior;
an absorbent pad;
wherein said absorbent pad is coupled to said hollow interior of said container; and
a lid adapted to snugly fit around said perimeter of said container.

16. The food storage container of claim 15, wherein said absorbent pad comprises fenestrations.

17. The food storage container of claim 15, wherein said absorbent pad comprises at least one selected from the group consisting of fenestrated cloth, fenestrated compressed sponges, and composite materials.

18. The food storage container of claim 15, wherein said absorbent pad is coupled to said bottom of said container by at least one rivet.

19. The food storage container of claim 15, wherein said container is comprised of thermoplastic material.

20. A food storage container comprising:
a container comprising a bottom and at least one sidewall;
wherein said sidewall extends upward from said bottom and forms a perimeter around said bottom, thereby creating a hollow interior;
an absorbent pad; and
a lid adapted to snugly fit around said perimeter of said container;
wherein said absorbent pad is coupled to said lid.

21. A method of maintaining the nutritional content of a food product comprising:
providing a food storage container;
providing an absorbent pad;
coupling said food storage container to said absorbent pad; and
absorbing excess liquid with said absorbent pad from a food product stored within said food storage container;
wherein said step of absorbing excess liquid occurs via capillary action.
